(19) United States
(12) Patent Application Publication
(10) Pub. No.: US 2014/0064610 A1
(43) Pub. Date: Mar. 6, 2014

(54) IMAGE PROCESSING DEVICE AND METHOD, PROGRAM, AND ELECTRONIC APPARATUS

(71) Applicant: Sony Corporation, Tokyo (JP)

(72) Inventor: Kazuyuki Matsushima, Kanagawa (JP)

(73) Assignee: Sony Corporation, Tokyo (JP)

(21) Appl. No.: 13/965,713

(22) Filed: Aug. 13, 2013

(30) Foreign Application Priority Data
Aug. 28, 2012 (JP) 2012-187599

(51) Int. Cl. G06K 9/36

(52) U.S. Cl. CPC G06K 9/36
USPC 382/162

(57) ABSTRACT

There is provided an image processing unit including a color space conversion unit that converts a first color space expressing an input image into a second color space, a frequency conversion unit that converts the input image expressed in the second color space into a frequency component, a CSF setting unit that sets a CSF (Contrast Sensitivity Function) corresponding to the second color space, and a level control unit that controls a level of the frequency component of the input image for each band according to the CSF.

### BACKGROUND

The present disclosure relates to an image processing device and method, a program, and an electronic apparatus, and particularly to an image processing device and method, a program, and an electronic apparatus that enable reduction of noise.

In the related art, a noise reduction process for reducing noise is performed on images.

For example, there is a technique for suppressing noise of a pixel of interest using a value of a peripheral pixel for which the difference between a value of the pixel of interest is within a threshold value (refer to, for example, Japanese Unexamined Patent Application Publication No. 2006-60744).

In addition, there is another technique for reducing noise by removing a frequency component of a corresponding color difference signal when a frequency component of a luminance signal is smaller than a predetermined threshold value (refer to, for example, Japanese Unexamined Patent Application Publication No. 2003-224861).

### SUMMARY

However, when the technique disclosed in Japanese Unexamined Patent Application Publication No. 2006-60744 is applied to an image having a fine spatial change, the portion having the fine change is crushed, which leads to deterioration of resolution.

In addition, the technique disclosed in Japanese Unexamined Patent Application Publication No. 2003-224861 does not exhibit a sufficient effect of suppressing noise in a specific frequency band since the necessity of noise removal is determined only using a threshold value. To be specific, since the technique disclosed in Japanese Unexamined Patent Application Publication No. 2003-224861 does not consider a characteristic of the visual sense of a human being, there is concern that a strong noise reduction process may be applied to a frequency band having high sensitivity to resolution, or a weak noise reduction process may be applied to a frequency band having high sensitivity to noise. As a result, there is concern of an obtained image having degraded image quality with lowered resolution and noise not being removed.

The present disclosure is made in light of the foregoing, and it is desirable to remove noise more effectively.

According to an embodiment of the present technology, there is provided an image processing device including a color space conversion unit that converts a first color space expressing an input image into a second color space, a frequency conversion unit that converts the input image expressed in the second color space into a frequency component, a CSF setting unit that sets a CSF (Contrast Sensitivity Function) corresponding to the second color space, and a level control unit that controls a level of the frequency component of the input image for each band according to the CSF.

The image processing device may further include a multiplication unit that multiplies the frequency component of the input image by the CSF. The level control unit may control a power spectrum level indicating that the frequency component of the input image that has been multiplied by the CSF is controlled for each band.

The level control unit may include a filter band setting unit that sets a filter band indicating a power spectrum serving as an ideal frequency component of the input image according to a parameter with regard to the input image, and a level adjustment unit that adjusts the power spectrum level of the input image for each band using the filter band.

The filter band setting unit may set the bandwidth of the frequency component and the filter band of the power spectrum level according to the parameter of the input image.

The level adjustment unit may adjust the power spectrum level of the input image for each band using a BPF (Band Pass Filter) corresponding to each band of the filter band.

The image processing device may further include a parameter setting unit that sets a parameter with regard to the input image.

According to an embodiment of the present technology, there is provided an image processing method performed by an image processing device that includes a color space conversion unit that converts a first color space expressing an input image into a second color space, a frequency conversion unit that converts the input image expressed in the second color space into a frequency component, a CSF setting unit that sets a CSF (Contrast Sensitivity Function) corresponding to the second color space, and a level control unit that controls a level of the frequency component of the input image for each band according to the CSF, the method including converting the first color space expressing an input image into the second color space, converting the input image expressed in the second color space into the frequency component, setting the CSF corresponding to the second color space, and controlling the level of the frequency component of the input image for each band according to the CSF.

According to an embodiment of the present technology, there is provided a program for causing a computer to function as a color space conversion unit that converts a first color space expressing an input image into a second color space, a frequency conversion unit that converts the input image expressed in the second color space into a frequency component, a CSF setting unit that sets a CSF (Contrast Sensitivity Function) corresponding to the second color space, and a level control unit that controls a level of the frequency component of the input image for each band according to the CSF.

According to an embodiment of the present technology, there is provided an electronic apparatus including an image processing unit that includes a color space conversion unit that converts a first color space expressing an input image into a second color space, a frequency conversion unit that converts the input image expressed in the second color space into a frequency component, a CSF setting unit that sets a CSF (Contrast Sensitivity Function) corresponding to the second color space, and a level control unit that controls a level of the frequency component of the input image for each band according to the CSF.

According to the embodiments of the present disclosure, a first color space expressing an input image is converted into a second color space, the input image expressed in the second color space is converted into a frequency component, a CSF corresponding to the second color space is set, and the level of the frequency component of the input image is controlled for each band according to the CSF.

According to the embodiments of the present disclosure described above, noise can be removed more effectively.

### BRIEF DESCRIPTION OF THE DRAWINGS

FIG. 1 is a block diagram showing a configuration example of an embodiment of an image processing device to which the present technology is applied;

FIG. 2 is a block diagram showing a configuration example of a level control unit;

FIG. 3 is a flowchart describing a noise reduction process;

FIG. 4 is a diagram illustrating frequency conversion;

FIG. 5 is a diagram showing an example of CSF;

FIG. 6 is a flowchart describing a level control process;

FIGS. 7A and 7B are graphs on which bandwidths of filter bands are plotted;

FIG. 8 is a graph on which levels of a filter band are plotted;

FIG. 9 is a graph on which an example of filter bands is plotted;

FIG. 10 is a diagram describing level adjustment for each band;

FIG. 11 is a diagram describing level adjustment for each band;

FIG. 12 is a diagram describing level adjustment for each band;

FIG. 13 is a block diagram showing a configuration example of an embodiment of a computer;

FIG. 14 is a block diagram showing a configuration example of an imaging device to which the present technology is applied;

FIG. 15 is a block diagram showing a configuration example of a television receiver set to which the present technology is applied;

FIG. 16 is a block diagram showing a configuration example of a mobile telephone to which the present technology is applied; and

FIG. 17 is a block diagram showing a configuration example of a printing apparatus to which the present technology is applied.

### DETAILED DESCRIPTION OF THE EMBODIMENT(S)

Hereinafter, preferred embodiments of the present disclosure will be described in detail with reference to the appended drawings.

### [Configuration Example of an Image Processing Device]

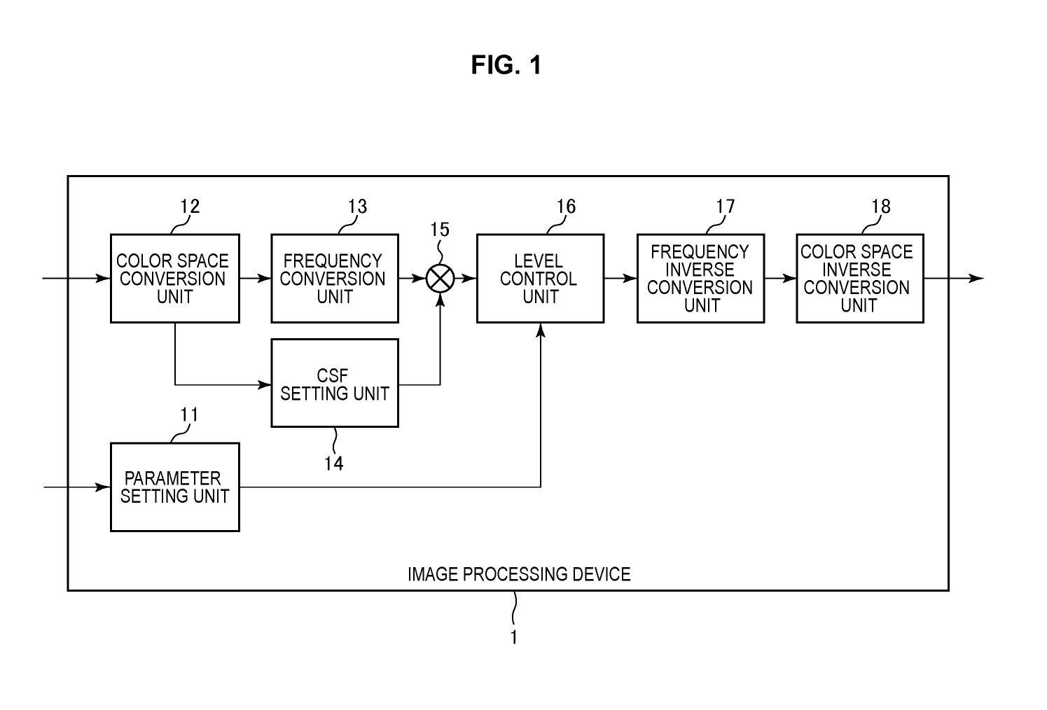

FIG. 1 is a block diagram showing a configuration example of an embodiment of an image processing device to which the present technology is applied.

The image processing device 1 of FIG. 1 performs a noise reduction process for removing noise on an input image that has been input thereto, in addition to performing a predetermined image process on the input image, and outputs an obtained image.

The image processing device 1 of FIG. 1 includes a parameter setting unit 11, a color space conversion unit 12, a frequency conversion unit 13, a CSF setting unit 14, a multiplication unit 15, a level control unit 16, a frequency inverse conversion unit 17, and a color space inverse conversion unit 18.

The parameter setting unit 11 sets parameters with regard to an input image, and supplies the parameters to the level control unit 16.

The color space conversion unit 12 converts a color space expressing values of pixels in the input image into another color space, and then supplies the input image including the pixels of the values expressed in the latter color space to the frequency conversion unit 13. In addition, the color space conversion unit 12 supplies information indicating the latter color space to the CSF setting unit 14.

The frequency conversion unit 13 converts a signal component of the input image expressed in the latter color space supplied from the color space conversion unit 12 into a frequency component, and then supplies data thereof to the multiplication unit 15.

The CSF setting unit 14 sets a CSF (Contrast Sensitivity Function) indicating a characteristic of the visual sense (spatial frequency characteristic) of a human being corresponding to the color space of the input image that has undergone the color space conversion based on information indicating the color space from the color space conversion unit 12, and supplies the CSF to the multiplication unit 15.

The multiplication unit 15 multiplies the CSF supplied from the CSF setting unit 14 by the frequency component of the input image supplied from the frequency conversion unit 13, and then supplies the result to the level control unit 16.

The level control unit 16 controls the level of a power spectrum (power spectrum level) indicating the frequency component of the input image that has been multiplied by the CSF and supplied from the multiplication unit 15 for each frequency band according to the parameters of the input image supplied from the parameter setting unit 11.

The frequency inverse conversion unit 17 inversely converts the frequency component of the input image supplied from the level control unit 16 into the original signal component, and then supplies the data to the color space inverse conversion unit 18.

The color space inverse conversion unit 18 inversely converts the color space expressing the values of the pixels of the input image supplied from the frequency inverse conversion unit 17 into the original color space, and then outputs the input image including the pixels of the values expressed in the original color space.

### [Configuration Example of the Level Control Unit]

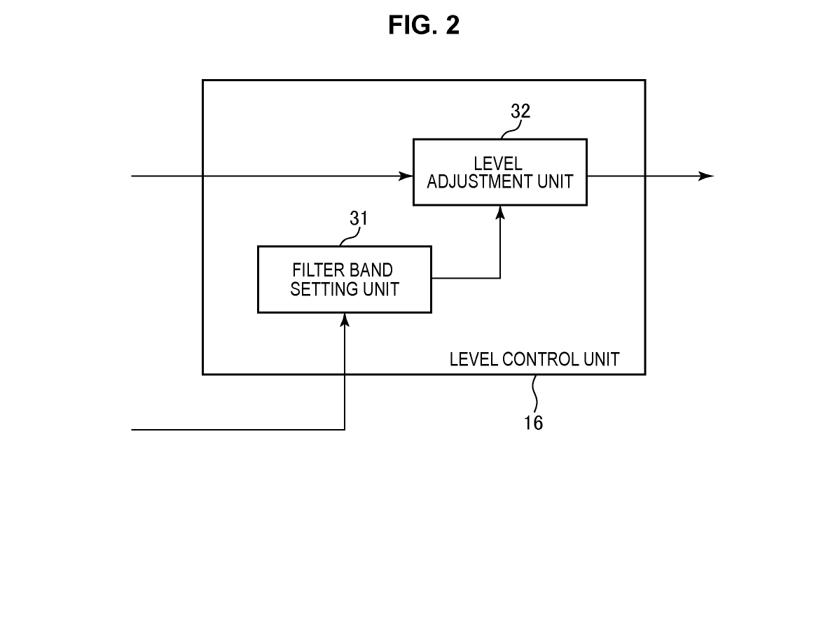

Next, a configuration example of the level control unit 16 of FIG. 1 will be described with reference to FIG. 2.

The level control unit 16 of FIG. 2 includes a filter band setting unit 31, and a level adjustment unit 32.

The filter band setting unit 31 sets a filter band indicating a power spectrum as an ideal frequency component of the input image according to the parameters of the input image supplied from the parameter setting unit 11, and then supplies the filter band to the level adjustment unit 32.

The level adjustment unit 32 adjusts the power spectrum level of the input image supplied from the multiplication unit 15 for each band so as to set the power spectrum level to be an ideal power spectrum using the filter band supplied from the filter band setting unit 31, and then supplies the result to the frequency inverse conversion unit 17.

### [Regarding a Noise Reduction Process]

Hereinafter, a noise reduction process performed by the image processing device 1 will be described.

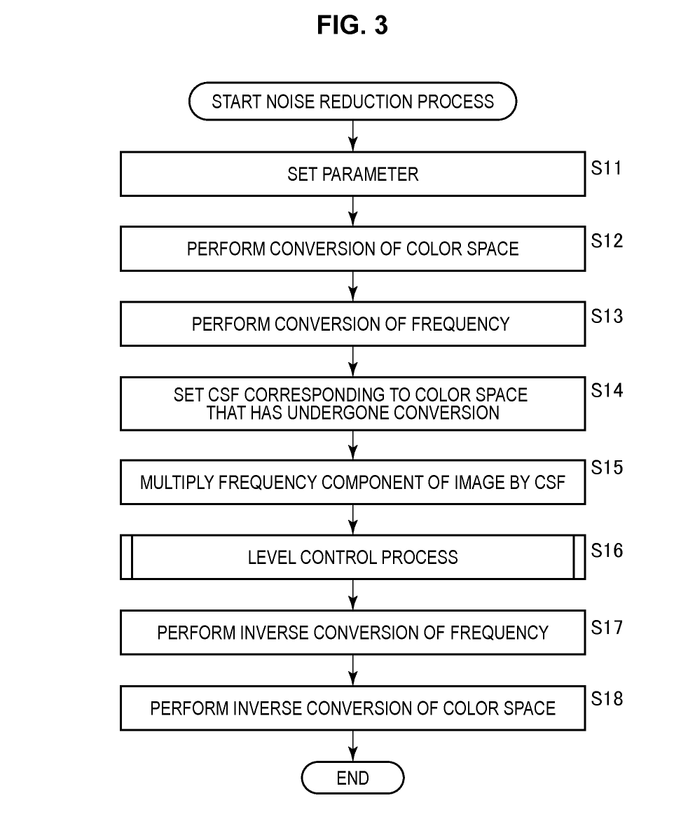

FIG. 3 is a flowchart describing the noise reduction process performed by the image processing device 1.

In Step S11, the parameter setting unit 11 sets information indicating, for example, an image-making idea (such as whether priority should be put on noise reduction or improvement of resolution, how to strike balance between noise reduction and improvement of resolution, or the like) as a parameter with regard to the input image. In addition, as a parameter, information indicating the category of a camera (for example, a digital camera, a camera mounted on a mobile telephone, a surveillance camera, or the like), information indicating an imaged scene (such as daylight, night view, fine weather, or cloudy weather), or information indicating a condition provided for the input image may be set.

It should be noted that the parameters may be set through analysis of the input image by the parameter setting unit 11, or set according to an operation input by a user.

The parameters set in this manner are supplied to the level control unit 16

In Step S12, the color space conversion unit 12 converts a color space expressing values of pixels of the input image. Here, an example of conversion from an RGB color space to the opposite color space will be described.

First, image data of the input image in an sRGB (standard RGB) color space given in Expression (1) (R_{sRGB}, G_{sRGB}, B_{sRGB}) is normalized to be 0 or 1 as shown in Expression (2).

R_{sRGB}=R

G_{sRGB}=G

B_{sRGB}=B (1)

R′_{sRGB}=R_{sRGB}/255

G′_{sRGB}=G_{sRGB}/255

B′_{sRGB}=B_{sRGB}/255 (2)

Here, when a gamma correction process is performed on the input image, an inverse gamma correction is performed on image data (R′_{sRGB}, G′_{sRGB}, B′_{sRGB}) given in Expression (2) so as to be as shown in Expression (3) or (4) below, and image data (R″_{sRGB}, G″_{sRGB}, B″_{sRGB}) is thereby obtained.

$$\begin{matrix}\begin{matrix}{R}_{sRGB}^{″} = {R}_{sRGB}^{′} / 12.92 \\ {G}_{sRGB}^{″} = {G}_{sRGB}^{′} / 12.92 \\ {B}_{sRGB}^{″} = {B}_{sRGB}^{′} / 12.92\end{matrix} ( \begin{matrix}{R}_{sRGB}^{′} \leq 0.04045 \\ {G}_{sRGB}^{′} \leq 0.04045 \\ {B}_{sRGB}^{′} \leq 0.04045\end{matrix} ) & ( 3 ) \\ \begin{matrix}{R}_{sRGB}^{″} = {( ( {R}_{sRGB}^{′} + 0.055 ) / 1.055 )}^{2.4} \\ {G}_{sRGB}^{″} = {( ( {G}_{sRGB}^{′} + 0.055 ) / 1.055 )}^{2.4} \\ {B}_{sRGB}^{″} = {( ( {B}_{sRGB}^{′} + 0.055 ) / 1.055 )}^{2.4}\end{matrix} ( \begin{matrix}{R}_{sRGB}^{′} \geq 0.04045 \\ {G}_{sRGB}^{′} \geq 0.04045 \\ {B}_{sRGB}^{′} \geq 0.04045\end{matrix} ) & ( 4 )\end{matrix}$$

It should be noted that Expression (3) is applied when each component R′_{sRGB}, G′_{sRGB}, and B′_{sRGB} of the image data is equal to or lower than 0.04045, and Expression (4) is applied when each component R′_{sRGB}, G′_{sRGB}, and B′_{sRGB} of the image data is equal to or higher than 0.04045.

Next, the image data (R″_{sRGB}, G″_{sRGB}, B″_{sRGB}) given in Expression (3) or (4) is converted into image data (X_{D}, Y_{D}, Z_{D}) of an XYZ color space (under a D65 light source) as shown in Expression (5) below.

$$( \begin{matrix}{X}_{D} \\ {Y}_{D} \\ {Z}_{D}\end{matrix} ) = ( \begin{matrix}0.4124 & 0.3576 & 0.1805 \\ 0.2126 & 0.7152 & 0.0722 \\ 0.0193 & 0.1192 & 0.9505\end{matrix} ) ( \begin{matrix}{R}_{sRGB}^{″} \\ {G}_{sRGB}^{″} \\ {B}_{sRGB}^{″}\end{matrix} ) \qquad ( 5 )$$

Furthermore, the image data (X_{D}, Y_{D}, Z_{D}) given in Expression (5) is converted into image data (X_{E}, Y_{E}, Z_{E}) under an E light source as shown in Expression (6) below.

$$( \begin{matrix}{X}_{E} \\ {Y}_{E} \\ {Z}_{E}\end{matrix} ) = ( \begin{matrix}1.016199 & 0.05563392 & - 0.01977148 \\ 0.0061101 & 0.9955345 & - 0.001233236 \\ 0 & 0 & 0.9182737\end{matrix} ) ( \begin{matrix}{X}_{D} \\ {Y}_{D} \\ {Z}_{D}\end{matrix} ) \qquad ( 6 )$$

In addition, the image data (X_{E}, Y_{E}, Z_{E}) given in Expression (6) is converted into a three-pair color system (white-black, red-green, and yellow-blue) of the opposite color space, and image data (S_{W-K}, S_{R-G}, S_{Y-B}) of the opposite color space as shown in Expression (7) below is thereby obtained.

S_{W-K}=Y_{E}

S_{R-G}=X_{E}−Y_{E}

S_{Y-B}=0.4×(Y_{E}−Z_{E}) (7)

In this manner, color space conversion from the RGB color space to the opposite color space is attained.

In addition, the color space conversion unit 12 supplies the input image of which the color space has been converted to the frequency conversion unit 13, and supplies the information indicating the converted color space to the CSF setting unit 14.

It should be noted that, in the above description, color space conversion to the opposite color space is assumed to be performed, but conversion is not limited thereto, and other kinds of color space conversion such as color space conversion to an L*a*b* space, or color space conversion to an L*u*v* space may be performed.

In Step S13, the frequency conversion unit 13 converts each signal component of the input image into frequency components by analyzing frequencies of the input image that is supplied from the color space conversion unit 12 after the color space conversion, and then supplies the components to the multiplication unit 15. For the frequency analysis performed on each signal component of the input image, for example, an FFT (Fast Fourier Transform), a DFT (Discrete Fourier Transform), a wavelet transform, or the like is performed.

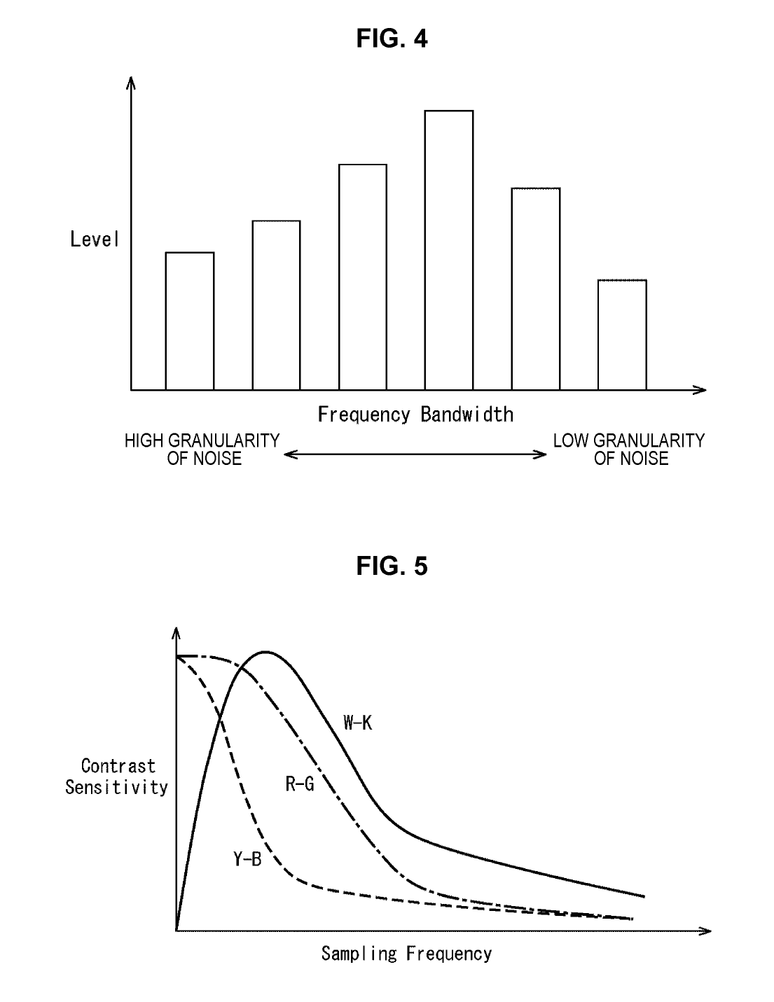

Accordingly, as the frequency components of each signal component of the input image, for example, power spectrum distribution as shown in FIG. 4 is obtained. In FIG. 4, the horizontal axis represents spatial frequencies, and the vertical axis represents intensities (levels) of the power spectrum. It should be noted that, when the input image includes noise, the spatial frequencies of the horizontal axis indicate roughness of noise, i.e., granularity of noise (size of grain). In other words, noise in a low frequency band has high granularity, and noise in a high frequency band has low granularity.

In Step S14, the CSF setting unit 14 sets a CSF corresponding to the color space of the input image that has undergone the color space conversion based on the information indicating the color space supplied from the color space conversion unit 12, and then supplies the CSF to the multiplication unit 15. CSFs are prepared in advance for each component of the color space, and set according to components of the color space of the input unit that has undergone the color space conversion. When the color space of the input image is converted from the RGB color space into the opposite color space, for example, CSFs respectively corresponding to components W-K, R-Q and Y-B of the opposite color space are set as shown in FIG. 5.

In FIG. 5, the horizontal axis represents spatial frequencies, the vertical axis represents sensitivity of the visual sense of a human being, and graphs indicated by the solid line, the dashed-dotted line, and the dashed line respectively show CSFs corresponding to the components W-K, R-Q and Y-B.

As shown in FIG. 5, sensitivity of the visual sense of a human being to the component W-K of the opposite color space is at the lowest level when the spatial frequency is 0, peaks on a certain spatial frequency, gradually decreases after the frequency, and becomes lower as the frequency becomes higher. In addition, sensitivity of the visual sense of a human being to the components R-G and Y-B of the opposite color space peaks when the spatial frequency is 0, gradually decreases after the frequency, and becomes lower as the frequency becomes higher.

Returning to the flowchart of FIG. 3, in Step S15, the multiplication unit 15 multiplies a CSF corresponding to each component supplied from the CSF setting unit 14 by a frequency component of each signal component of the input image supplied from the frequency conversion unit 13, and then supplies the result to the level control unit 16. The frequency component multiplied by the CSF is expressed as a power spectrum in which sensitivity of the visual sense of a human being is considered.

In Step S16, the level control unit 16 executes a level control process in which the power spectrum level of the input image of which the frequency component is multiplied by the CSF supplied from the multiplication unit 15 is controlled for each frequency band according to the parameters of the input image supplied from the parameter setting unit 11.

### [Regarding a Level Control Process]

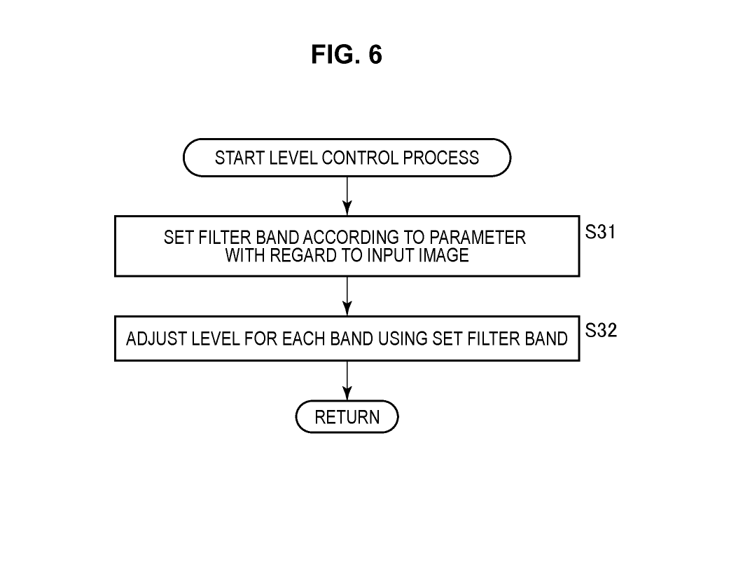

Herein, the level control process executed by the level control unit 16 will be described with reference to the flowchart of FIG. 6.

In Step S31, the filter band setting unit 31 sets a filter band according to the parameters with regard to the input image supplied from the parameter setting unit 11. To be specific, the filter band setting unit 31 sets a filter band having bandwidths and power spectrum levels of each band of frequency components according to the parameters with regard to the input image.

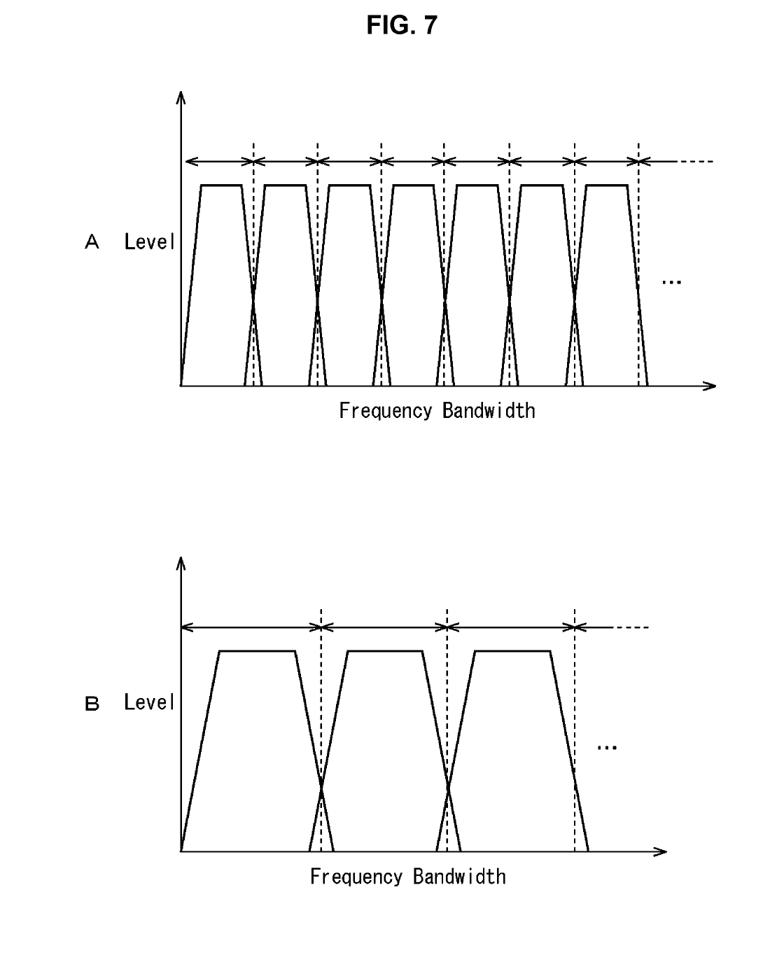

For example, the filter band setting unit 31 performs setting in such a way that the bandwidth of the filter band is finely divided as shown in FIG. 7A, or the bandwidth of the filter band is roughly divided as shown in FIG. 7B according to information indicating an imaged scene as a parameter with regard to the input image.

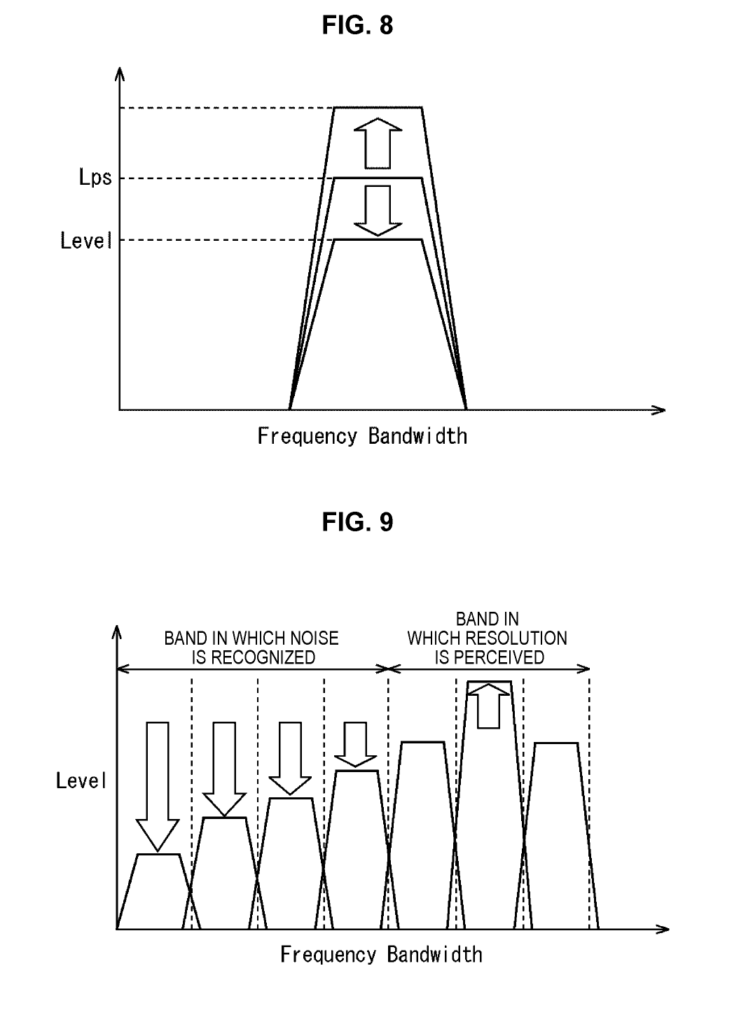

In addition, the filter band setting unit 31 performs setting in such a way that a power spectrum level is set to be higher or lower than a predetermined level Lps for each divided filter band as shown in FIG. 8 according to information indicating an image-making idea as a parameter with regard to the input image. It should be noted that a power spectrum level set here may be decided based on, for example, a CSF set by the CSF setting unit 14.

In this manner, for example, filter bands are set as shown in FIG. 9.

The filter bands shown in FIG. 9 are divided so as to have the bandwidth shown in FIG. 7A, the power spectrum levels of the band in which the visual sense of a human being recognizes noise are set to become lower as the frequency band becomes lower, and the power spectrum level in the intermediate band outside of the bands in which the visual sense of a human being perceives resolution is set to be high.

Using the filter bands obtained in this manner, the power spectrum levels of the input image are adjusted for each band.

In other words, in Step S32, the level adjustment unit 32 adjusts (matches) the power spectrum levels of the input image supplied from the multiplication unit 15 for each band so as to set an ideal power spectrum proper for the parameters with regard to the input image, using the filter bands supplied from the filter band setting unit 31.

To be specific, the level adjustment unit 32 adjusts the power spectrum levels of the input image for each band using BPFs (Band Pass Filters) corresponding to each band of the filter bands. Using the BPFs, a power spectrum level of a desired band can be adjusted.

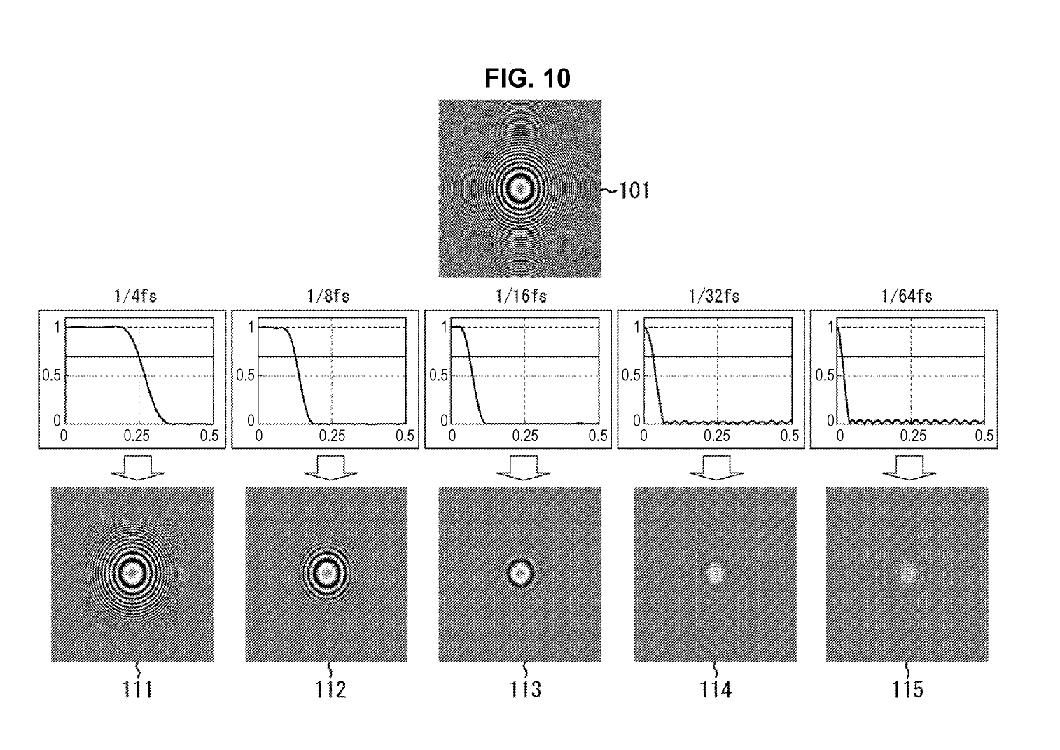

Here, the adjustment of the power spectrum levels for each band using the BPFs will be described with reference to FIGS. 10 to 12. Herein, an example using CZPs (Circular Zone Plates) as frequency components of the input image will be described. A CZP is an image expressing sine (or cosine) curves in a two-dimensional manner, by arranging many layers of concentric circles having the center of the image as the origin, and a spatial frequency thereof gradually increases from the center to the outer side.

First, the level adjustment unit 32 performs filtering processes using five kinds of LPFs (Low Pass Filters) on a CZP 101 as shown in FIG. 10. In the example of FIG. 10, the filtering processes use the LPFs which cause frequency components of ¼ fs, ⅛ fs, 1/16 fs, 1/32 fs, and 1/64 fs and lower to penetrate therethrough with respect to a sampling frequency fs, and CZPs 111 to 115 which have undergone the filtering process are obtained. The CZP 111 that has undergone the filtering processes is an image obtained by cutting off spatial frequencies of from an intermediate frequency band to a high frequency band of the CZP 101, and as the images that have undergone the filtering processes get close to the CZP 115, cut-off frequency bands in the CZP 101 expand to the lower frequency band side.

Next, the level adjustment unit 32 extracts a frequency component of a desired band in the CZP 101. To be specific, a frequency component of a desired band in the CZP 101 is extracted by having two differences from the CZPs 111 to 115 that have undergone the filtering processes.

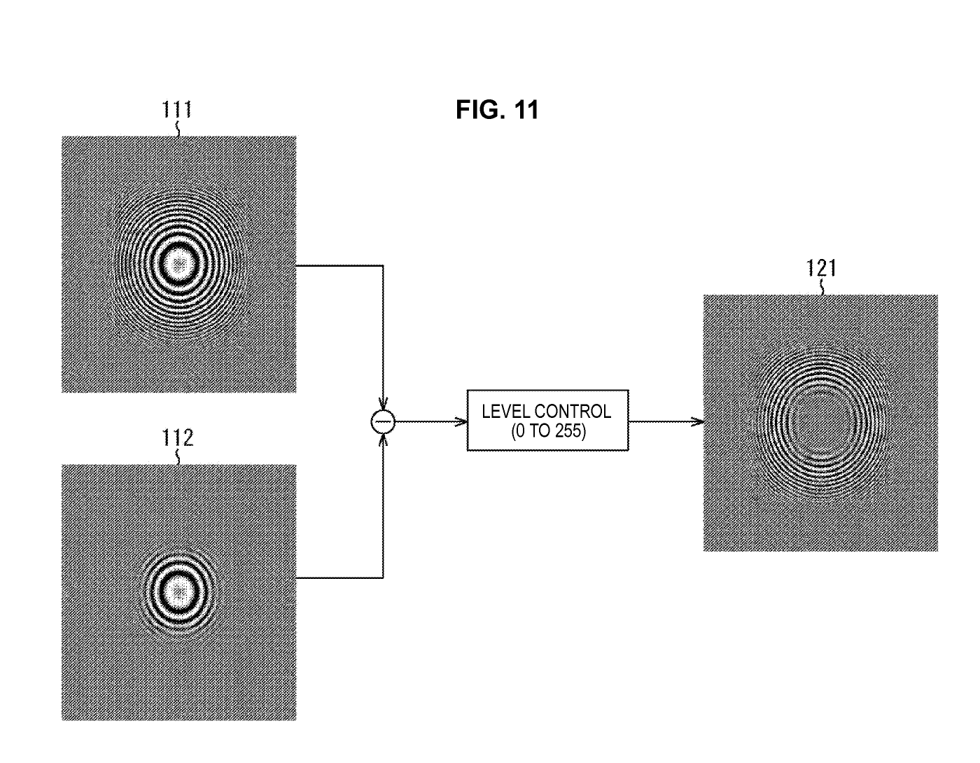

For example, as shown in FIG. 11, the difference between the CZP 111 and the CZP 112 that have undergone the filtering processes is obtained, level control from 0 to 255 is performed on the result, and thereby a CZP 121 obtained by penetrating frequency components between ⅛ fs and ¼ fs is obtained. This is equivalent to performing, on the CZP 101 that is the input image, a filtering process using a BPF which causes frequency components between ⅛ fs and ¼ fs to penetrate therethrough. It should be noted that the level control from 0 to 255 is performed according to the amount of level adjustment of a band to be adjusted in the frequency components of the input image.

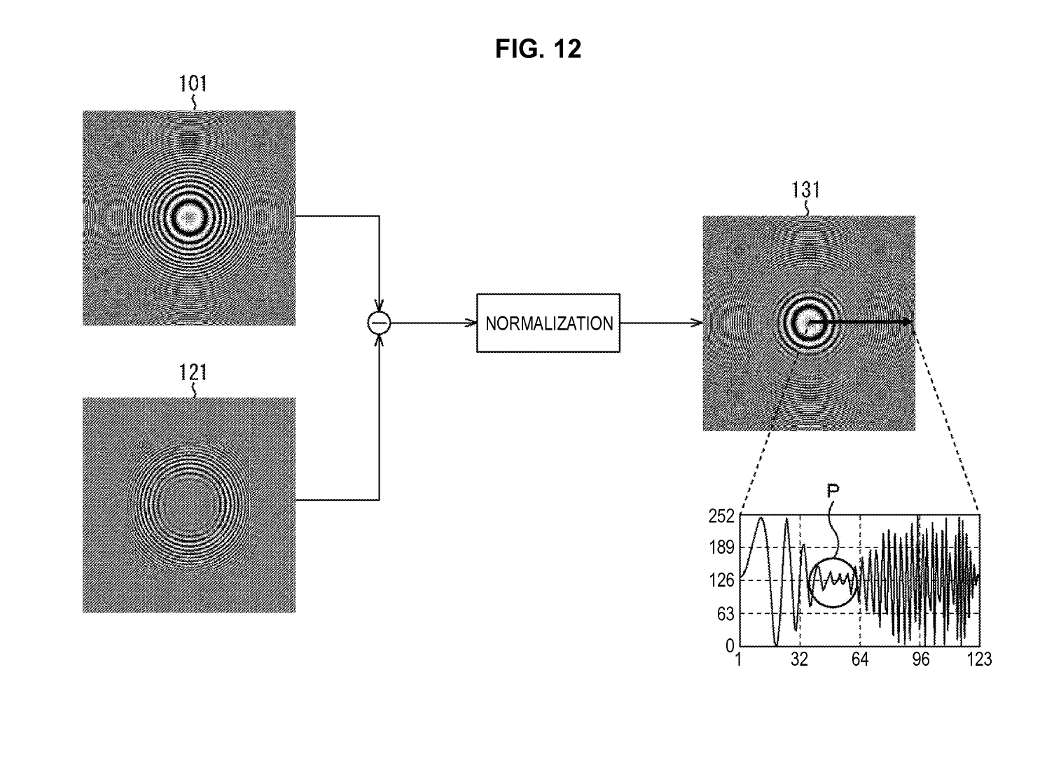

In addition, the level adjustment unit 32 adjusts the power spectrum levels of the input image with regard to the band corresponding to the BPF by having the difference between the CZP 101 as the input image and the CZP 121 on which the BPF process is performed and normalizing the difference as shown in, for example, FIG. 12. In the sine curves corresponding to a CZP 131 obtained as a result of the adjustment, the amplitude of a band P indicating the penetration band of the BPF is adjusted to be small.

In this manner, the frequency components of the input image of which the power spectrum levels are controlled to be ideal levels are supplied to the frequency inverse conversion unit 17, and the process returns to Step S16 of the flowchart of FIG. 3.

It should be noted that, when the power spectrum levels are not controlled to be ideal levels through one level control process, the level control process is repeated until the power spectrum levels are controlled to be ideal levels.

After Step S16, the frequency inverse conversion unit 17 inversely converts the frequency components of the input image supplied from the level control unit 16 into the original signal components in Step S17, and then supplies the result to the color space inverse conversion unit 18. Here, the frequency inverse conversion corresponding to the frequency conversion performed in Step S13 is performed.

In Step S18, the color space inverse conversion unit 18 inversely converts the color space expressing the input image supplied from the frequency inverse conversion unit 17 into the original color space, and outputs an image expressed by the original color space. Here, color space inverse conversion corresponding to the color space conversion performed in Step S12 is performed.

According to the above process, since the power spectrum levels indicating the frequency components of the input image are controlled for each band according to the CSF corresponding to the converted color space of the input image, a noise reduction process considering a characteristic of the visual sense of a human being can be performed on the input image, and noise can thereby be removed more effectively.

In addition, since the characteristic of the visual sense of a human being is considered in the noise reduction process, excessive noise correction can be avoided, and a scale of a circuit according thereto can be reduced.

Furthermore, since a filter band indicating the power spectrum as an ideal frequency component of the input image is set according to the parameters with regard to the input image, an image in which feelings of noise and resolution are balanced can be obtained. In other words, noise can be removed in a frequency band in which sensitivity to noise is high, and resolution can be enhanced in a frequency band in which sensitivity to resolution is high.

It should be noted that, in the above-described process, it is assumed that the power spectrum levels are set for each bandwidth or band of filter bands according to the parameters with regard to the input image, but filter bands having the power spectrum levels for each bandwidth or band corresponding to the parameters with regard to the input image may be prepared in advance, and corresponding filter bands may be selected according to the parameters with regard to the input image.

In addition, according to the present technology, since a power spectrum level can be controlled in a specific band, an edge of an image can be blurry, or an effect can be applied thereto.

Furthermore, when the present technology is applied to benchmarking such as image quality evaluation, the idea of a signal process performed on an image to be evaluated can be easily analyzed.

In addition, by using the filter band of the present technology as a target value of noise distribution in the course of manufacturing a solid-state imaging device (image sensor), efficiency in quality conformance work of solid-state imaging devices can be attained, and solid-state imaging devices with high accuracy can be shipped.

It should be noted that the above-described process is repeated in units of one frame or several frames when the input image is a moving image. Thus, even when a change is made in an image, for example, when an imaged scene is switched, the filter band is optimally changed, and thus a noise reduction process appropriate for an input image can be performed to the extent that the visual sense of a human being does not perceive discomfort.

[Explanation of Computer to which the Present Technology is Applied]

The series of processes described above can be executed by hardware but can also be executed by software. When the series of processes is executed by software, a program that constructs such software is installed into a computer. Here, the expression “computer” includes a computer in which dedicated hardware is incorporated and a general-purpose personal computer or the like that is capable of executing various functions when various programs are installed.

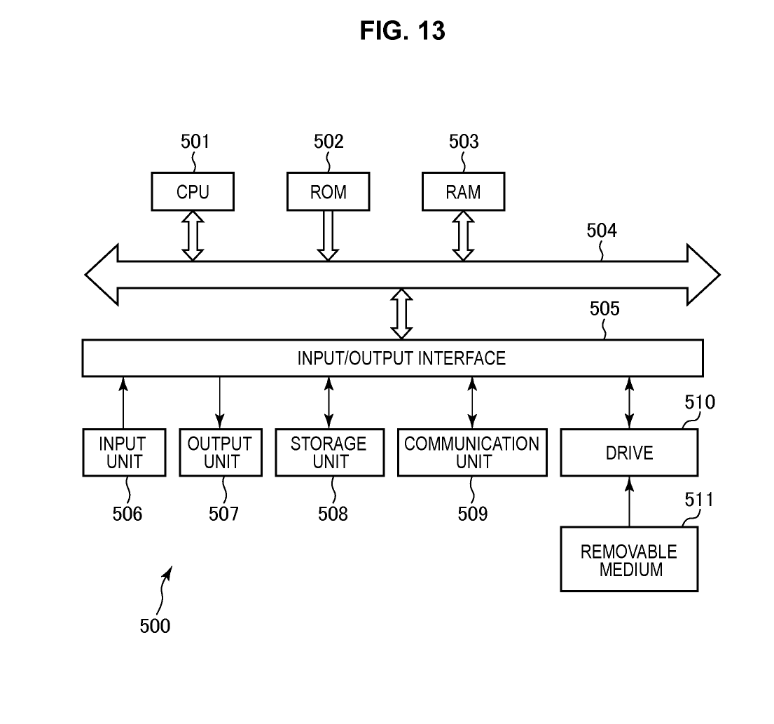

FIG. 13 is a block diagram showing a hardware configuration example of a computer that performs the above-described series of processing using a program.

In the computer, a central processing unit (CPU) 501, a read only memory (ROM) 502 and a random access memory (RAM) 503 are mutually connected by a bus 504.

An input/output interface 505 is also connected to the bus 504. An input unit 506, an output unit 507, a storage unit 508, a communication unit 509, and a drive 510 are connected to the input/output interface 505.

The input unit 506 is configured from a keyboard, a mouse, a microphone or the like. The output unit 507 is configured from a display, a speaker or the like. The storage unit 508 is configured from a hard disk, a non-volatile memory or the like. The communication unit 509 is configured from a network interface or the like. The drive 510 drives a removable media 511 such as a magnetic disk, an optical disk, a magneto-optical disk, a semiconductor memory or the like.

In the computer 500 configured as described above, the CPU 501 loads a program that is stored, for example, in the storage unit 508 onto the RAM 503 via the input/output interface 505 and the bus 504, and executes the program. Thus, the above-described series of processing is performed.

Programs to be executed by the computer 500 (the CPU 501) are provided being recorded in the removable media 511 which is a packaged media or the like. Also, programs may be provided via a wired or wireless transmission medium, such as a local area network, the Internet or digital satellite broadcasting.

In the computer 500, by inserting the removable media 511 into the drive 510, the program can be installed in the storage unit 508 via the input/output interface 505. Further, the program can be received by the communication unit 509 via a wired or wireless transmission media and installed in the storage unit 508. Moreover, the program can be installed in advance in the 5OM 502 or the storage unit 508.

It should be noted that the program executed by the computer 500 may be a program that is processed in time series according to the sequence described in this specification or a program that is processed in parallel or at necessary timing such as upon calling.

Furthermore, the present technology can be applied to arbitrary electronic apparatuses. Hereinbelow, examples thereof will be described.

### [Configuration Example of an Imaging Device]

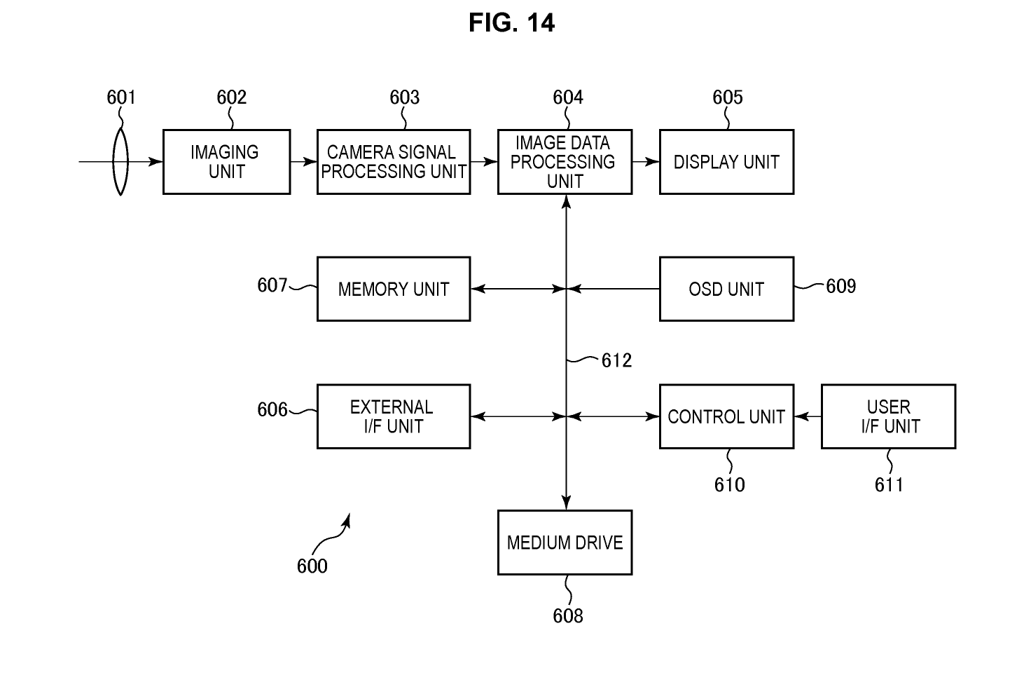

FIG. 14 shows a configuration example of an imaging device to which the present technology is applied. The imaging device 600 images subjects, displays the images of the subjects on a display unit, and records the images as image data in a recording medium.

The imaging device 600 includes an optical block 601, an imaging unit 602, a camera signal processing unit 603, an image data processing unit 604, a display unit 605, an external interface unit 606, a memory unit 607, a medium drive 608, an OSD (On Screen Display) unit 609, and a control unit 610. In addition, the control unit 610 is connected to a user interface unit 611. Furthermore, the image data processing unit 604, the external interface unit 606, the memory unit 607, the medium drive 608, the OSD unit 609, and the control unit 610 are connected to one another via a bus 612.

The optical block 601 is constituted by a focus lens, a diaphragm mechanism, and the like. The optical block 601 forms an optical image of a subject on an imaging face of the imaging unit 602. The imaging unit 602 includes a CCD (Charge Coupled Device) or a CMOS (Complementary Metal Oxide Semiconductor) image sensor, generates electric signals according to an optical image through photoelectric conversion, and then supplies the signals to the camera signal processing unit 603.

The camera signal processing unit 603 performs various camera signal processes such as gamma correction or color correction on the electric signals supplied from the imaging unit 602. The camera signal processing unit 603 supplies image data that has undergone the camera signal process to the image data processing unit 604.

It should be noted that the imaging unit 602 and the camera signal processing unit 603 may be formed as independent units, or as an integrated unit (one chip) of a flat setting type, a laminated type, or the like.

The image data processing unit 604 performs an encoding process of the image data supplied from the camera signal processing unit 603. The image data processing unit 604 supplies encoded data generated by performing the encoding process to the external interface unit 606 and the medium drive 608. In addition, the image data processing unit 604 performs a decoding process of encoded data supplied from the external interface unit 606 and the medium drive 608. The image data processing unit 604 supplies image data generated by performing the decoding process to the display unit 605. In addition, the image data processing unit 604 supplies the image data supplied from the camera signal processing unit 603 to the display unit 605, or supplies data for display acquired from the OSD unit 609 to the display unit 605 by superimposing the data on the image data.

The OSD unit 609 generates data for display such as a menu screen, or an icon formed using symbols, text, or figures and outputs the data to the image data processing unit 604.

The external interface unit 606 includes, for example, USB (Universal Serial Bus) input and output terminals, or the like, and is connected to a printing apparatus when an image is to be printed. In addition, a drive is connected to the external interface unit 606 if necessary, a removable medium such as a magnetic disk or an optical disc is appropriately loaded thereon, and a computer program read from the medium is installed if necessary. Furthermore, the external interface unit 606 has a network interface connected to a predetermined network such as a LAN, the Internet, or the like. The control unit 610 can read encoded data from the memory unit 607 according to an instruction from, for example, the user interface unit 611, and can cause the data to be supplied from the external interface unit 606 to another device connected via a network. In addition, the control unit 610 can acquire encoded data or image data supplied from another device via a network through the external interface unit 606, or can supply the data to the image data processing unit 604.

As a recording medium driven in the medium drive 608, an arbitrary readable and writable removable medium, for example, a magnetic disk, a magneto-optical disc, an optical disc, or a semiconductor memory, is used.

In addition, such a recording medium may be configured as a non-portable recording medium formed by integrating the medium drive 608 and a recording medium, for example, a built-in hard disk drive, an SSD (Solid State Drive), or the like.

The control unit 610 is configured using a CPU, a memory, and the like. The memory stores programs executed by the CPU, various kinds of data necessary for the CPU performing processes, and the like. The programs stored in the memory are read and executed by the CPU at predetermined time points such as activation of the imaging device 600, and the like. The CPU controls each unit by executing the programs so that the imaging device 600 works according to operations of a user.

In the camera signal processing unit 603 of the imaging device configured as above, the function of the image processing device (image processing method) of the present technology is provided.

Accordingly, since the power spectrum levels indicating frequency components of image data are controlled for each band according to a CSF corresponding to a color space of image data, a noise reduction process in which a characteristic of the visual sense of a human being is considered can be performed on the image data, and noise can accordingly be removed more effectively.

[Configuration Example of a Television Receiver Set]

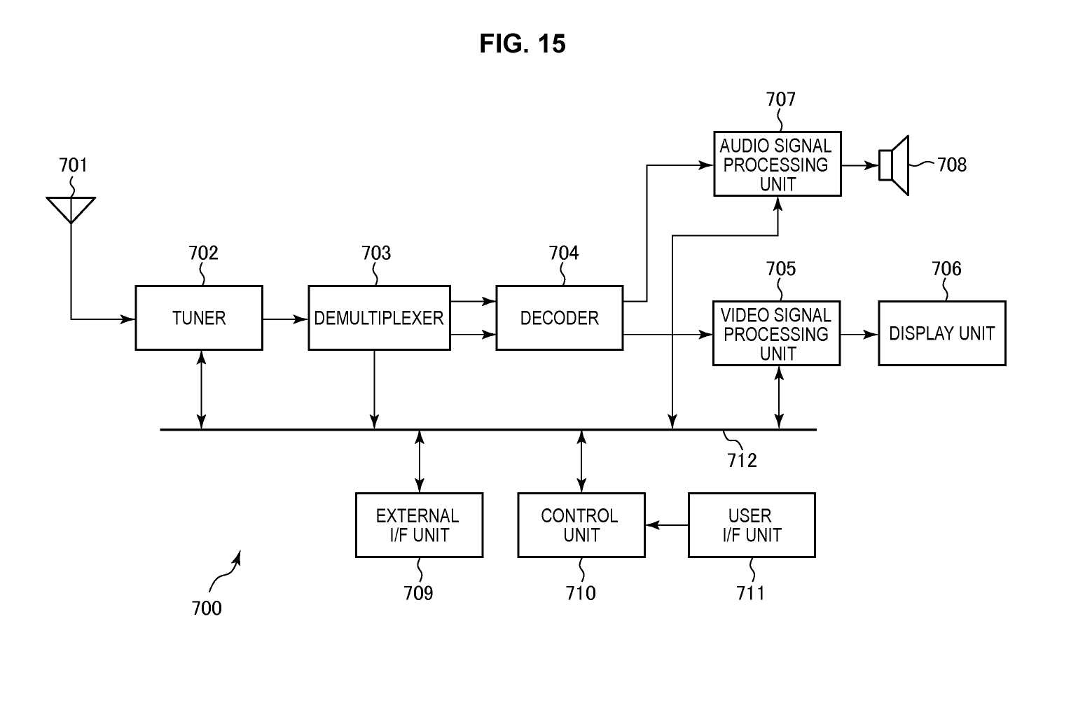

FIG. 15 shows a configuration example of a television receiver set to which the present technology is applied. The television receiver set 700 has an antenna 701, a tuner 702, a demultiplexer 703, a decoder 704, a video signal processing unit 705, a display unit 706, an audio signal processing unit 707, a speaker 708, and an external interface unit 709. Furthermore, the television receiver set 700 has a control unit 710 and a user interface unit 711.

The tuner 702 performs demodulation by selecting a desired channel from broadcasting wave signals received using the antenna 701, and outputs obtained encoded bit streams to the demultiplexer 703.

The demultiplexer 703 extracts video and audio packets of a program to be viewed from the encoded bit streams, and outputs data of the extracted packets to the decoder 704. In addition, the demultiplexer 703 supplies packets of data such as an EPG (Electronic Program Guide) to the control unit 710. It should be noted that, when scrambling is performed, the demultiplexer 703 or the like performs descrambling.

The decoder 704 performs a decoding process on the packets, and outputs video data generated from the decoding process to the video signal processing unit 705 and audio data generated therefrom to the audio signal processing unit 707.

The video signal processing unit 705 performs a video process, or the like on the video data according to noise removal or a user setting. The video signal processing unit 705 generates video data of a program to be displayed on the display unit 706, or image data through a process based on an application supplied via a network. In addition, the video signal processing unit 705 generates video data for displaying a menu screen for selecting items, and the like, and superimposes the data on the video data of the program. The video signal processing unit 705 generates drive signals based on the video data generated as described above to drive the display unit 706.

The display unit 706 drives a display device (for example, a liquid crystal display element, or the like) based on the drive signals from the video signal processing unit 705 to display videos of the program, and the like thereon.

The audio signal processing unit 707 performs a predetermined process such as noise removal, or the like, on the audio data, and outputs sound by performing a D/A (Digital to Analog) conversion process, and an amplification process on the audio data that has undergone the predetermined process and then supplying the data to the speaker 708.

The external interface unit 709 is an interface for connecting an external device and a network, and performs data exchange of video data, audio data, and the like.

The user interface unit 711 is connected to the control unit 710. The user interface unit 711 includes an operation switch, a remote control signal reception unit, and the like, and supplies operation signals according to user operations to the control unit 710.

The control unit 710 is configured using a CPU, a memory, and the like. The memory stores programs executed by the CPU, various kinds of data necessary for the CPU to perform processes, EPG data, data acquired via a network, and the like. The programs stored in the memory are read and executed by the CPU at a predetermined time point such as at the time of activation of the television receiver set 700. The CPU controls each unit by executing the programs so that the television receiver set 700 works according to user operations.

It should be noted that the television receiver set 700 is provided with a bus 712 for connecting the control unit 710 to the tuner 702, the demultiplexer 703, the video signal processing unit 705, the audio signal processing unit 707, and the external interface unit 709.

The video signal processing unit 705 of the television receiver set configured as above has the function of the image processing device (image processing method) of the present technology.

Accordingly, since power spectrum levels indicating frequency components of video data are controlled for each band according to a CSF corresponding to a color space of the video data, a noise reduction process in which a characteristic of the visual sense of a human being is considered can be performed on the video data, and noise thereof can be removed more effectively.

### [Configuration Example of a Mobile Telephone]

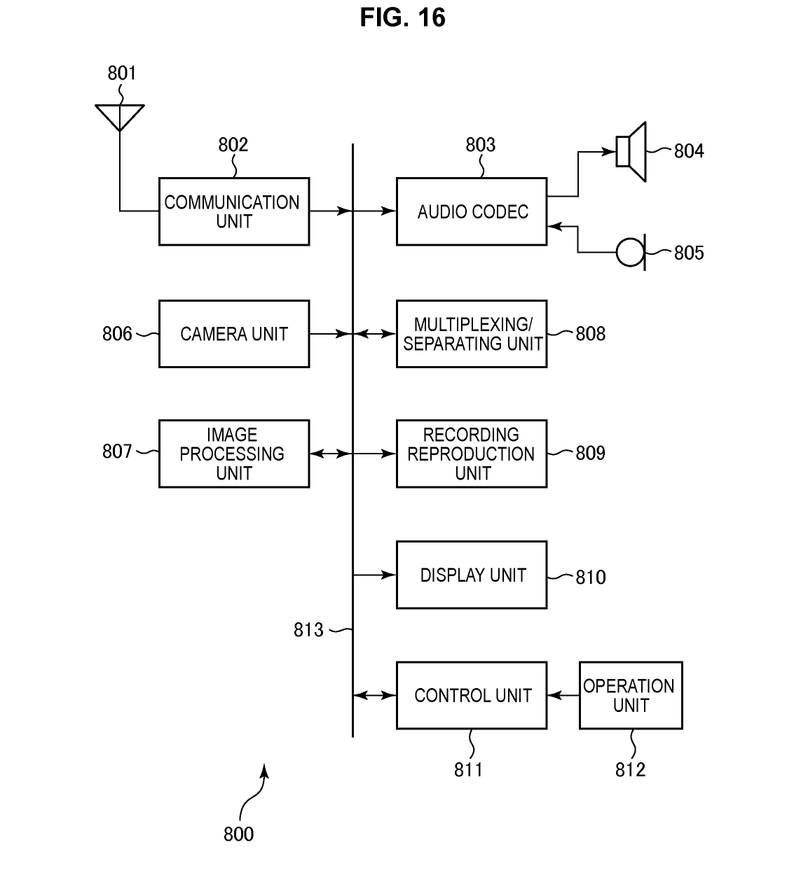

FIG. 16 shows a configuration example of a mobile telephone to which the present technology is applied. The mobile telephone 800 has a communication unit 802, an audio codec 803, a camera unit 806, an image processing unit 807, a multiplexing/separating unit 808, a recording reproduction unit 809, a display unit 810, and a control unit 811. The units are connected to one another via a bus 813.

In addition, an antenna 801 is connected to the communication unit 802, and a speaker 804 and a microphone 805 are connected to the audio codec 803. Furthermore, an operation unit 812 is connected to the control unit 811.

The mobile telephone 800 performs exchange of audio signals, exchange of e-mails and image data, and various operations of photographing images, recording data, or the like in various modes of a voice call mode, a data communication mode, and the like.

In the voice call mode, voice signals generated from the microphone 805 are converted into voice data or compressed as data in the audio codec 803 and then supplied to the communication unit 802. The communication unit 802 performs a modulation process, a frequency conversion process, and the like on the voice data to generate transmission signals. In addition, the communication unit 802 supplies the transmission signals to the antenna 801, and then transmits the signals to a base station not shown in the drawing. In addition, the communication unit 802 performs amplification, a frequency conversion process, a demodulation process, and the like on reception signals received using the antenna 801, and supplies obtained voice data to the audio codec 803. The audio codec 803 performs data extension of the voice data, and conversion into analog voice signals, and outputs the signals to the speaker 804.

In addition, when an e-mail is transmitted in the data communication mode, the control unit 811 receives text data input through an operation of the operation unit 812, and causes the input text to be displayed on the display unit 810. In addition, the control unit 811 generates mail data based on a user instruction, or the like in the operation unit 812, and supplies the data to the communication unit 802. The communication unit 802 performs a modulation process, a frequency conversion process, and the like on the mail data, and transmits obtained transmission signals through the antenna 801. In addition, the communication unit 802 performs amplification, a frequency conversion process, a demodulation process, and the like on reception signal received using the antenna 801, and restores mail data. The communication unit supplies the mail data to the display unit 810 so as to display the content of the mail.

It should be noted that the mobile telephone 800 can also cause the recording reproduction unit 809 to store the received mail data in a recording medium. The recording medium is an arbitrary rewritable recording medium. The recording medium is, for example, a semiconductor memory such as a RAM, or a built-in flash memory, or a removable medium such as a hard disk, a magnetic disk, a magneto-optical disc, an optical disc, a USB memory, or a memory card.

When image data is transmitted in the data communication mode, image data generated in the camera unit 806 is supplied to the image processing unit 807. The image processing unit 807 performs an encoding process on the image data, and thereby generates encoded data.

The multiplexing/separating unit 808 multiplexes the encoded data generated in the image processing unit 807 and the voice data supplied from the audio codec 803 in a predetermined format, and supplies the multiplexed data to the communication unit 802. The communication unit 802 performs a modulation process, a frequency conversion process, and the like on the multiplexed data, and transmits obtained transmission signals through the antenna 801. In addition, the communication unit 802 performs amplification, a frequency conversion process, a demodulation process, and the like on reception signals received using the antenna 801 to restore multiplexed data. This multiplexed data is supplied to the multiplexing/separating unit 808. The multiplexing/separating unit 808 demultiplexes the multiplexed data, and supplies the encoded data to the image processing unit 807, and the voice data to the audio codec 803. The image processing unit 807 performs a decoding process on the encoded data, and thereby generates image data. This image data is supplied to the display unit 810 to display a received image. The audio codec 803 converts the voice data into analog voice signals, then supplies the signals to the speaker 804, and outputs received voices.

The image processing unit 807 of the mobile telephone configured as above has the function of the image processing device (image processing method) of the present technology.

Accordingly, since power spectrum levels indicating frequency components of image data are controlled for each band according to a CSF corresponding to a color space of the image data, a noise reduction process in which a characteristic of the visual sense of a human being is considered can be performed on the image data, and noise thereof can be removed more effectively.

### [Configuration Example of a Printing Apparatus]

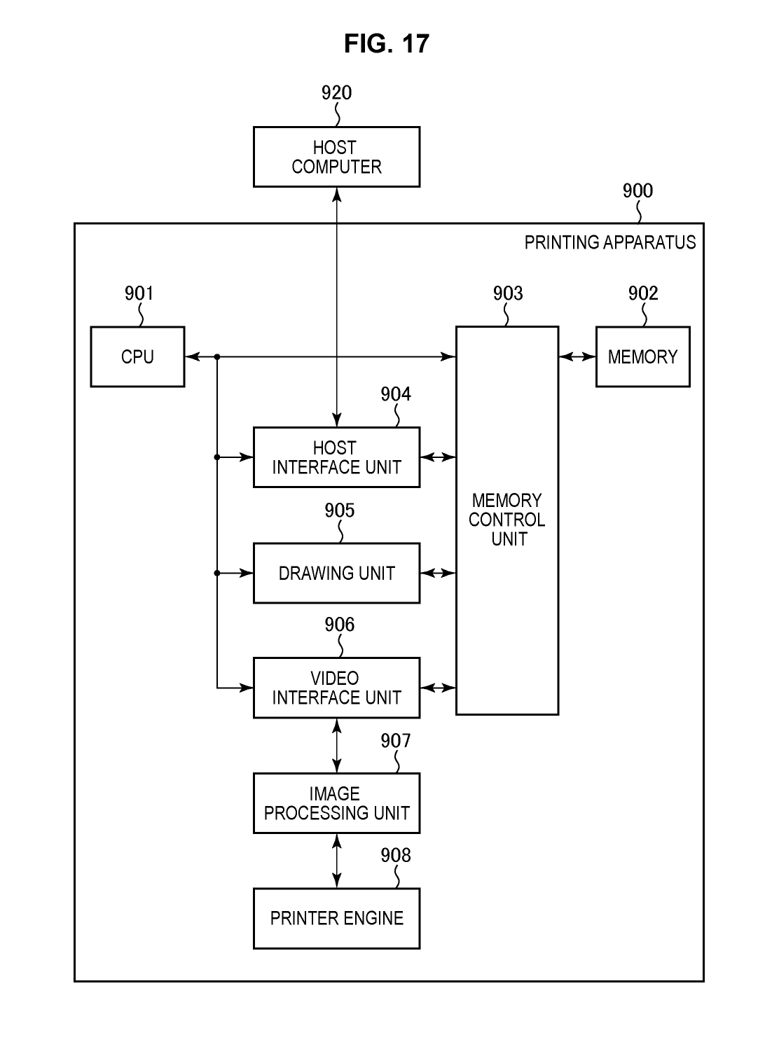

FIG. 17 shows a configuration example of a printing apparatus to which the present technology is applied. The printing apparatus 900 is provided with a CPU 901, a memory 902, a memory control unit 903, a host interface (host I/F) unit 904, a drawing unit 905, a video interface (video I/F) unit 906, an image processing unit 907, and a printer engine 908, and is connected to a host computer 920 so as to communicate therewith.

The CPU 901 is a central processing device taking charge of controlling the entire printing apparatus, and causes the image processing unit 907 to execute various image processes based on a control program stored in the memory 902. The memory 902 stores the control program executed by the CPU 901, data received from the host computer 920, bitmap image data generated by the drawing unit 905, and the like. The memory control unit 903 controls access to the memory 902 from the CPU 901, the host I/F unit 904, the drawing unit 905, and the video I/F unit 906. The host I/F unit 904 takes charge of communication between the printing apparatus 900 and the host computer 920. The drawing unit 905 generates bitmap image data.

The video I/F unit 906 converts data drawn on the memory 902 into serial video signals. The image processing unit 907 converts target pixels so as to have high resolution according to pixel data in the periphery of the target pixel data. The printer engine 908 has two laser light sources, and performs printing operations in which laser beams emitted from each laser light source are radiated on a photosensitive drum, a latent image is thereby formed on the photosensitive drum, the latent image is developed, and accordingly, an image is transferred onto a print medium.

The image processing unit 907 of the printing apparatus configured as above has the function of the image processing device (image processing method) of the present technology.

Accordingly, since power spectrum levels indicating frequency components of image data are controlled for each band according to a CSF corresponding to a color space of the image data, a noise reduction process in which a characteristic of the visual sense of a human being is considered can be performed on the image data, and noise thereof can be removed more effectively.

It should be understood by those skilled in the art that various modifications, combinations, sub-combinations and alterations may occur depending on design requirements and other factors insofar as they are within the scope of the appended claims or the equivalents thereof.

In addition, the present technology can adopt a configuration of cloud computing in which one function is distributed to and jointly processed by a plurality of devices via a network.

In addition, each step described in the flowcharts above can be executed by one device, and can also be distributed to a plurality of devices for the execution.

Furthermore, when one step includes a plurality of processes, the plurality of processes included in the step can be executed by one device, and can also be distributed to a plurality of devices for the execution.

Additionally, the present technology may also be configured as below.

(1)
An image processing device including:

a color space conversion unit that converts a first color space expressing an input image into a second color space;

a frequency conversion unit that converts the input image expressed in the second color space into a frequency component;

a CSF setting unit that sets a CSF (Contrast Sensitivity Function) corresponding to the second color space; and

a level control unit that controls a level of the frequency component of the input image for each band according to the CSF.

(2)
The image processing device according to (1), further including:

a multiplication unit that multiplies the frequency component of the input image by the CSF,

wherein the level control unit controls a power spectrum level indicating that the frequency component of the input image that has been multiplied by the CSF is controlled for each band.

(3)
The image processing device according to (2), wherein the level control unit includes a filter band setting unit that sets a filter band indicating a power spectrum serving as an ideal frequency component of the input image according to a parameter with regard to the input image, and a level adjustment unit that adjusts the power spectrum level of the input image for each band using the filter band.
(4)
The image processing device according to (3), wherein the filter band setting unit sets the bandwidth of the frequency component and the filter band of the power spectrum level according to the parameter of the input image.
(5)
The image processing device according to (3) or (4), wherein the level adjustment unit adjusts the power spectrum level of the input image for each band using a BPF (Band Pass Filter) corresponding to each band of the filter band.
(6)
The image processing device according to any one of (3) to (5), further including:

a parameter setting unit that sets a parameter with regard to the input image.

(7)
An image processing method performed by an image processing device that includes a color space conversion unit that converts a first color space expressing an input image into a second color space, a frequency conversion unit that converts the input image expressed in the second color space into a frequency component, a CSF setting unit that sets a CSF (Contrast Sensitivity Function) corresponding to the second color space, and a level control unit that controls a level of the frequency component of the input image for each band according to the CSF, the method including:

converting the first color space expressing an input image into the second color space;

converting the input image expressed in the second color space into the frequency component;

setting the CSF corresponding to the second color space; and

controlling the level of the frequency component of the input image for each band according to the CSF.

(8)
A program for causing a computer to function as:

a color space conversion unit that converts a first color space expressing an input image into a second color space;

a frequency conversion unit that converts the input image expressed in the second color space into a frequency component;

a CSF setting unit that sets a CSF (Contrast Sensitivity Function) corresponding to the second color space; and

a level control unit that controls a level of the frequency component of the input image for each band according to the CSF.

(9)
An electronic apparatus including:

an image processing unit that includes a color space conversion unit that converts a first color space expressing an input image into a second color space, a frequency conversion unit that converts the input image expressed in the second color space into a frequency component, a CSF setting unit that sets a CSF (Contrast Sensitivity Function) corresponding to the second color space, and a level control unit that controls a level of the frequency component of the input image for each band according to the CSF.

The present disclosure contains subject matter related to that disclosed in Japanese Priority Patent Application JP 2012-187599 filed in the Japan Patent Office on Aug. 28, 2012, the entire content of which is hereby incorporated by reference.

What is claimed is:

1. An image processing device comprising:
a color space conversion unit that converts a first color space expressing an input image into a second color space;
a frequency conversion unit that converts the input image expressed in the second color space into a frequency component;
a CSF setting unit that sets a CSF (Contrast Sensitivity Function) corresponding to the second color space; and
a level control unit that controls a level of the frequency component of the input image for each band according to the CSF.

2. The image processing device according to claim 1, further comprising:
a multiplication unit that multiplies the frequency component of the input image by the CSF,
wherein the level control unit controls a power spectrum level indicating that the frequency component of the input image that has been multiplied by the CSF is controlled for each band.

3. The image processing device according to claim 2, wherein the level control unit includes a filter band setting unit that sets a filter band indicating a power spectrum serving as an ideal frequency component of the input image according to a parameter with regard to the input image, and a level adjustment unit that adjusts the power spectrum level of the input image for each band using the filter band.

4. The image processing device according to claim 3, wherein the filter band setting unit sets the bandwidth of the frequency component and the filter band of the power spectrum level according to the parameter of the input image.

5. The image processing device according to claim 3, wherein the level adjustment unit adjusts the power spectrum level of the input image for each band using a BPF (Band Pass Filter) corresponding to each band of the filter band.

6. The image processing device according to claim 3, further comprising:
a parameter setting unit that sets a parameter with regard to the input image.

7. An image processing method performed by an image processing device that includes a color space conversion unit that converts a first color space expressing an input image into a second color space, a frequency conversion unit that converts the input image expressed in the second color space into a frequency component, a CSF setting unit that sets a CSF (Contrast Sensitivity Function) corresponding to the second color space, and a level control unit that controls a level of the frequency component of the input image for each band according to the CSF, the method comprising:
converting the first color space expressing an input image into the second color space;
converting the input image expressed in the second color space into the frequency component;
setting the CSF corresponding to the second color space; and
controlling the level of the frequency component of the input image for each band according to the CSF.

8. A program for causing a computer to function as:
a color space conversion unit that converts a first color space expressing an input image into a second color space;
a frequency conversion unit that converts the input image expressed in the second color space into a frequency component;
a CSF setting unit that sets a CSF (Contrast Sensitivity Function) corresponding to the second color space; and
a level control unit that controls a level of the frequency component of the input image for each band according to the CSF.

9. An electronic apparatus comprising:
an image processing unit that includes a color space conversion unit that converts a first color space expressing an input image into a second color space, a frequency conversion unit that converts the input image expressed in the second color space into a frequency component, a CSF setting unit that sets a CSF (Contrast Sensitivity Function) corresponding to the second color space, and a level control unit that controls a level of the frequency component of the input image for each band according to the CSF.
